(19) United States
(12) Patent Application Publication
(10) Pub. No.: US 2025/0045638 A1
(43) Pub. Date: Feb. 6, 2025

(54) DATA CLASSIFICATION

(71) Applicant: Lemon Inc., Grand Cayman (KY)

(72) Inventors: Yukun Ma, VANCOUVER (CA); Nipun Rustagi, VANCOUVER (CA)

(21) Appl. No.: 18/920,692

(22) Filed: Oct. 18, 2024

(51) Int. Cl. G06N 20/00; G06F 18/241

(52) U.S. Cl. CPC G06N 20/00; G06F 18/241

(57) ABSTRACT

There are provided methods, devices, and computer program products for data classification. A sample for training a machine learning model is obtained. The sample comprises a prompt and a response for the prompt, the prompt comprises input data, and the response comprises a classification of the input data, and a reason why the input data belongs to the classification. A first sample is determined based on the input data and the classification of the input data, and the first sample comprises a first prompt and a first response. A second sample is determined based on the input data, the classification of the input data, and the reason, and the second sample comprises a second prompt and a second response. The machine learning model is updated based on the first and the second samples. Therefore, the machine learning model may be updated in a more reliable and accurate way.

### FIELD

The present disclosure generally relates to machine learning, and more specifically, to methods, devices and computer program products for data classification.

### BACKGROUND

With continual technological developments in the field of machine learning, specifically the innovation and development of language models, their integration and applications have become common in various fields and industries. Nonetheless, there are considerable number of challenges pertaining to the application and utilization of machine learning models especially when a Chain-of-Thought (CoT) response is required along with their primary prediction for the associated task. At this point, it is desired to improve the performance of machine learning models when the CoT response is required.

### SUMMARY

In a first aspect of the present disclosure, there is provided a method for data classification. In the method, a sample for training a machine learning model is obtained. The sample comprises a prompt and a response for the prompt, the prompt comprises input data, and the response comprises a classification of the input data, and a reason why the input data belongs to the classification. A first sample is determined based on the input data and the classification of the input data, and the first sample comprises a first prompt and a first response. A second sample is determined based on the input data, the classification of the input data, and the reason, and the second sample comprises a second prompt and a second response. The machine learning model is updated based on the first and the second samples.

In a second aspect of the present disclosure, there is provided an electronic device. The electronic device comprises: a computer processor coupled to a computer-readable memory unit, the memory unit comprising instructions that when executed by the computer processor implements a method according to the first aspect of the present disclosure.

In a third aspect of the present disclosure, there is provided a computer program product, the computer program product comprising a computer readable storage medium having program instructions embodied therewith, the program instructions executable by an electronic device to cause the electronic device to perform a method according to the first aspect of the present disclosure.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE SEVERAL VIEWS OF THE DRAWINGS

Through the more detailed description of some implementations of the present disclosure in the accompanying drawings, the above and other objects, features and advantages of the present disclosure will become more apparent, wherein the same reference generally refers to the same components in the implementations of the present disclosure.

FIG. 1 illustrates a schematic diagram of a machine learning model being trained with a single prompt;

FIG. 2 illustrates an example diagram of data classification according to implementations of the present disclosure;

FIG. 3 illustrates an example diagram of the sample according to implementations of the present disclosure;

FIG. 4 illustrates an example diagram of a task being divided according to implementations of the present disclosure;

FIG. 5A illustrates an example diagram of the first template according to implementations of the present disclosure;

FIG. 5B illustrates an example diagram of the second template according to implementations of the present disclosure;

FIG. 6 illustrates an example diagram of construction of a dataset for training the machine learning model according to implementations of the present disclosure;

FIG. 7 illustrates an example flowchart of a method for data classification according to implementations of the present disclosure; and

FIG. 8 illustrates a block diagram of a computing device in which various implementations of the present disclosure can be implemented.

### DETAILED DESCRIPTION

Principle of the present disclosure will now be described with reference to some implementations. It is to be understood that these implementations are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one implementation,” “an implementation,” “an example implementation,” and the like indicate that the implementation described may include a particular feature, structure, or characteristic, but it is not necessary that every implementation includes the particular feature, structure, or characteristic. Moreover, such phrases are not necessarily referring to the same implementation. Further, when a particular feature, structure, or characteristic is described in connection with an example implementation, it is submitted that it is within the knowledge of one skilled in the art to affect such feature, structure, or characteristic in connection with other implementations whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example implementations. As used herein, the term “and/or” includes any and all combinations of one or more of the listed terms.

The terminology used herein is for the purpose of describing particular implementations only and is not intended to be limiting of example implementations. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

Principle of the present disclosure will now be described with reference to some implementations. It is to be understood that these implementations are described only for the purpose of illustration and help those skilled in the art to understand and implement the present disclosure, without suggesting any limitation as to the scope of the disclosure. The disclosure described herein can be implemented in various manners other than the ones described below. In the following description and claims, unless defined otherwise, all technical and scientific terms used herein have the same meaning as commonly understood by one of ordinary skills in the art to which this disclosure belongs.

It may be understood that data involved in the present technical solution (including but not limited to the data itself, the acquisition or use of the data) should comply with requirements of corresponding laws and regulations and relevant rules.

It may be understood that, before using the technical solutions disclosed in various implementation of the present disclosure, the user should be informed of the type, scope of use, and use scenario of the personal information involved in the present disclosure in an appropriate manner in accordance with relevant laws and regulations, and the user's authorization should be obtained.

For example, in response to receiving an active request from the user, prompt information is sent to the user to explicitly inform the user that the requested operation will need to acquire and use the user's personal information. Therefore, the user may independently choose, according to the prompt information, whether to provide the personal information to software or hardware such as electronic devices, applications, servers, or storage media that perform operations of the technical solutions of the present disclosure.

As an optional but non-limiting implementation, in response to receiving an active request from the user, the way of sending prompt information to the user, for example, may include a pop-up window, and the prompt information may be presented in the form of text in the pop-up window. In addition, the pop-up window may also carry a selection control for the user to choose “agree” or “disagree” to provide the personal information to the electronic device.

It may be understood that the above process of notifying and obtaining the user authorization is only illustrative and does not limit the implementation of the present disclosure. Other methods that satisfy relevant laws and regulations are also applicable to the implementation of the present disclosure.

As briefly mentioned above, machine learning models have become common in various fields and industries. Machine learning models may include millions, even billions of model parameters and require a significant source of input data for training. These parameters, however, are designed and distributed various hierarchical structures within the model architecture and can capture intricate inter-relationships within the input data. For instance, machine learning models may determine and map the intricate relations within image pixels, chereme of speech and text. The advantage of machine learning model is comprised in its inherent depth in capturing relationships. Due to the large number of parameters of a machine learning model, the model has an inherent ability to understand and map complex, abstract relationships and concepts and not just simple patterns as opposed to small models. Therefore, the machine learning models are good at complex tasks such as image recognition, natural language processing, speech and audio analysis.

Nonetheless, there are a number of challenges pertaining to the application and utilization of machine learning models. First, their training and development require a large amount of computing resources and thus their performance and training may be subjected to the limitation of their hardware and software availability. Second, the complexity and scale of these machine learning models are correlated to the increase in optimizing and adjusting model parameters. Additionally, machine learning models may be more sensitive to noise and anomalies in input data, which may affect the accuracy of their predictions and outputs based on the justification and reasoning it generates for its prediction. The challenges are specifically evident when problems which require a CoT response along with its primary prediction for the associated task are encountered.

The CoT refers to the model's line of reasoning it generates to justify its primary prediction task. For example, the image classification problem and text classification problem may fall under the CoT classification problem, involving the model to not only predict and categorize the image/text to a particular class/label, but also provide a justification/line of reasoning as to why the image/text falls under the predicted class/label. For example, images containing tall buildings and skyscrapers may be predicted by the machine learning model to be classified as “downtown” with the model's CoT response being “skyscrapers are more likely to be indicative of the downtown”. A text consisting of a movie review may be predicted by the machine learning model to be classified as “positive opinion”, with the model's CoT response being “the review contains complimentary opinions regarding the movie”.

For the above classification tasks, the following three approaches are used to train the machine learning model to do classification with the consideration of CoT.

In the first approach, a pretrained machine learning model is directly re-utilized, where the input data (image/text) is formatted into part of the prompt, which is passed to the machine learning model for prediction regarding its class/label and CoT reasoning. This approach is concise and does not require supervised fine-tuning as it directly uses the model's existing capabilities and saves numerous model training-related issues. In addition, this approach is practical for scenarios requiring minimal structural responses, and following a few prompt structures, the model may give a good answer. However, this approach may only be applied to scenarios requiring a specific structural formatted response. Furthermore, the model may face the length limit issue in its responses if the prompt is highly specialized, and the model's understanding ability will also decrease. This approach is only applicable to simple prompts, for very complex prompts without examples, the model is difficult to respond accurately.

In the second approach, the input data is annotated with its actual class/label along with CoT reasoning to form a training dataset which is utilized to supervise and fine-tune the trained machine learning model, thereby improving the effectiveness and accuracy of the machine learning model in terms of its class prediction and reasoning behind it. Regarding this approach, structural similarity of the responses may be learned into model parameters through training samples, which makes the model more accurate and concise in terms of its reasoning behind responses and its primary class prediction. In addition, this approach enables customization of models for multiple applications and tasks in different domains, making them versatile and flexible to meet various industry requirements. However, training models require additional resources, such as GPU units, larger memory storage, higher electricity requirements etc. In order to train the model efficiently, the quality of the training dataset data along with the CoT justification is required to be very high, and the data matching ratio is also required to be high.

In the third approach, the input data is annotated with its actual class/label along with CoT reasoning to form a training dataset which is utilized to first supervise and fine-tune the trained machine learning model. Then, the model output prediction along with the CoT is compared with the actual class/label and CoT, human annotated response is utilized to further fine-tune the model so that its generations are more along the lines of the human annotated response. This not only increases the effectiveness and accuracy of the machine learning model in terms of its class prediction and reasoning behind it, but also improves the structural development of its reasoning to be more along the lines of the annotated human response. Regarding this approach, alignment with human preference data enables the model to understand and align more closely with human preference and reasoning, possibly reducing the error rate in its prediction. The model becomes more robust to unusual or adversarial inputs by learning from human intervention. However, resource consumption is high, especially when consisting of a large dataset, as it requires significant human resources for continuous preference feedback. Models trained using reinforcement learning from human feedback (RLHF) may suffer from issues such as hallucinations and bias, which not only further decreases model accuracy but also has a potential to scrutinize business security and confidential information. Furthermore, alignment with human feedback decreases the diversity of samples produced by the model, thereby leading to a model degeneration/collapse as it deviates from the original prediction optimization to human preference optimization.

As can be seen from the above, although the second approach may solve the problem of CoT-based classification, which uses the supervised fine-tuning method to fine-tune the machine learning model. However, the common practice of this fine-tuning scheme is to collect existing business data and then fine-tune this business data with a single prompt requesting the primary classification/label and the CoT reasoning with an objective comprising two tasks. The first task is to accurately identify/classify the input text into a predefined class/label and the second task is to provide a detailed justification/explanation for predicting the following class/label.

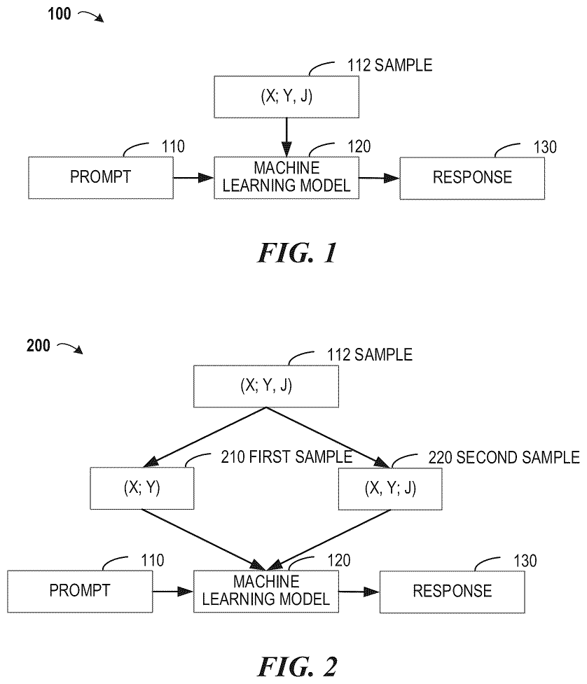

FIG. 1 illustrates a schematic diagram of a machine learning model being trained with a single prompt. As shown in FIG. 1, a sample 112 for training a machine learning model 120 is obtained. The sample 112 includes a prompt 110 comprising input data (denoted as X) and a response 130 comprising a classification (denoted as Y) of the input data and a reason (denoted as J) why the input data belongs to the classification. The machine learning model 120 is updated based on the sample 112. However, the single prompt scheme may have the following shortcomings. Firstly, business data often consists of complex and varied datasets indicating significant data sparsity. Combining these two tasks within a single prompt increases the model's cognitive load, making it more challenging to optimize both classification and CoT reasoning simultaneously, thereby affecting the overall model performance as it may lead to increased errors in both classification and reasoning. Furthermore, integrating the task of classification and CoT-based reasoning in a single prompt further creates a higher sequential dependency on the models completions and predictions, and thus if the model makes an error in classification, it will propagate to the CoT reasoning and lead to a compounded error effect that can degrade the overall performance and reliability of the model.

In view of the above, the present disclosure proposes a solution for data classification with reference to FIG. 2, which illustrates an example diagram 200 of data classification according to implementations of the present disclosure. As illustrated in FIG. 2, a sample 112 for training a machine learning model 120 is obtained. The sample 112 comprises a prompt 110 and a response 130 for the prompt 110. The prompt comprises input data (denoted as X), and the response comprises a classification (denoted as Y) of the input data, and a reason (denoted as J) why the input data belongs to the classification. A first sample 210 is determined based on the input data and the classification of the input data. The first sample 210 comprises a first prompt and a first response. A second sample 220 is determined based on the input data, the classification of the input data, and the reason. The second sample 220 comprises a second prompt and a second response. The machine learning model 120 is updated based on the first and the second samples.

With these implementations of the present disclosure, the sample for training the machine learning model may be divided into the first sample for training the classification capability of the machine learning model and the second sample for training the reasoning capability of the machine learning model, the first and second samples are separately used to train the machine learning model. In this way, the machine learning model may focus solely on classification first and then consequently generating a CoT reasoning behind it. This division reduces the cognitive burden on the model, enabling it perform each task with greater precision and effectiveness.

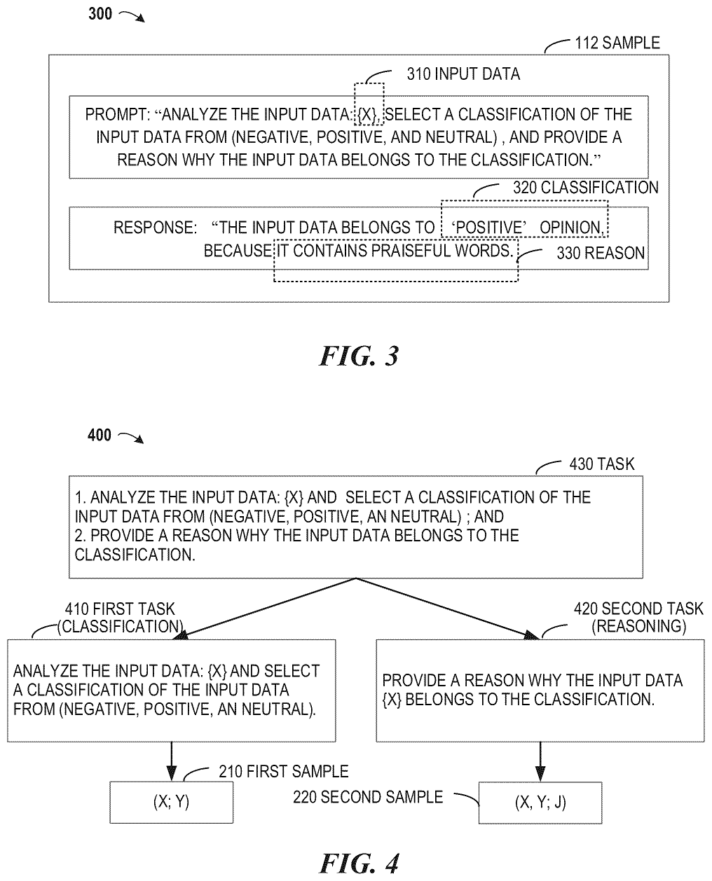

An example of the sample 112 will be described with reference to FIG. 3, which illustrates an example diagram 300 of the sample 112 according to implementations of the present disclosure. As shown in FIG. 3, the sample 112 may include a prompt and a response for the prompt. The prompt may include input data 310, a potential classification (e.g., negative, positive, and neutral opinions) of the input data 310 and a sentence to instruct the machine learning model 120 to provide reason why the input data 310 belongs to the classification. The response may include a classification 320 the input data 310 belongs to and a reason 330 why the input data 310 belongs to the classification 320.

In implementations of the present disclosure, the machine learning model may implement a task for outputting a classification of target data and a response why the target data belongs to the classification. The task may be divided into a first task and a second task that is implemented after the first task. The first task outputs a classification of the target data, and the second task outputs a response why the target data belongs to the classification. An example of a division of a task will be described with reference to FIG. 4, which illustrates an example diagram 400 of a task being divided according to implementations of the present disclosure.

As shown in FIG. 4, a task 430 may be configured to output a classification of target data and a response why the target data belongs to the classification. The task 430 may be divided into a first task 410 outputting the classification and a second task outputting the reasoning. The first sample 210 may be obtained, according to the first task 410, based on the input data and the classification of the input data. In an example, the first sample 210 may include input data and the classification of the input data. The second sample 220 may be obtained, according to the second task, based on the input data, the classification of the input data, and the reason. In an example, the second sample 220 may include the input data, the classification of the input data, and the reason.

With these implementations of the present disclosure, by dividing the task, each prompt focuses on a specific aspect, simplifying the machine learning model's cognitive load. Therefore, the machine learning model may be fine-tuned independently for classification and reasoning, allowing for targeted optimization that improves overall performance of the machine learning model. Since the two-prompt model treats the classification and CoT reasoning as independent tasks, errors in the first task (classification) are less likely to affect the second task (reasoning), thereby minimizing the risk of error propagation and leading to more reliable and accurate predictions in both stages. This is supported by the probabilistic analysis and derivations on the proposed two-prompt model. By breaking down the tasks independently, the compounded error rates that are common in single-prompt models are reduced which may be supported by the probabilistic framework derived from the two-prompt model and the single-prompt model provided in the following.

In a single-prompt model, the joint probability of correct classification and justification applying Bayes rule is P(Ŷ=Y,Ĵ=J|X)=P(Ŷ=Y|X)*P(Ĵ=J|Ŷ,X), where X represents input text (also referred to as input data), Y represents correct label or classification, Ŷ represents predicted label or classification, J represents justification/explanation (also referred to as reason) and Ĵ represents generated justification/explanation.

In the proposed two-prompt model, the task is divided into the first task and the second task. The first task is configured to classify the input text, and the probability of correct classification may be formulated as P(Ŷ=Y|X). The second task is configured to provide justification based on the classified label, and the probability of correct justification may be formulated as P(Ĵ=J|Ŷ=Y,X). Therefore, based on the probability of the responses from each model discussed above, the overall combined error for each model response may be calculated, that is, how much the model responses deviate from the correct label/classification and original justification.

In the single-prompt model, the combined error may be expressed as follows:

$$P ( \hat{Y} \neq Y or \hat{J} \neq J \vert X ) = 1 - P ( \hat{Y} = Y \vert X ) * P ( \hat{J} = J \vert \hat{Y} , X ) \qquad ( 1 )$$

In the proposed two-prompt model, an independent error for the first task may be expressed as follows:

$$P ( \hat{Y} \neq Y \vert X ) = 1 - P ( \hat{Y} = Y \vert X ) \qquad ( 2 )$$

An independent error for the second task may be expressed as follows:

$$P ( \hat{J} \neq J \vert \hat{Y} = Y , X ) = 1 - P ( \hat{J} = J \vert \hat{Y} = Y , X ) \qquad ( 3 )$$

Given the independence of the two tasks, the inclusion-exclusion principle of probability may be applied. Therefore, the combined error for the two-prompt model may be expressed as follows:

$$P ( Combined Error ) = P ( \hat{Y} \neq Y \vert X ) + P ( \hat{J} \neq J \vert \hat{Y} = Y , X ) - P ( \hat{Y} \neq Y \vert X ) * P ( \hat{J} \neq J \vert \hat{Y} = Y , X ) \qquad ( 4 )$$

Eq. (1) may be derived from Eq. (4), but the error of each task (i.e., Eq. (2) and Eq. (3)) is less than Eq. (1). When comparing the independent error rates of the proposed two-prompt system for CoT-based classification tasks with the traditional single-prompt system in terms of model accuracy for classifying input text and CoT-justification, since P(Ŷ=Y|X) which represents probability of correctly classifying the input text and P(Ĵ=J|Ŷ=Y,X) which represents the probability of accurately providing a justification for the classified label, are larger than P(Ŷ=Y|X)*P(Ĵ=J|Ŷ,X) which represents the joint probability of correct classification and justification, P(Ŷ≠Y|X) and P(Ĵ≠J|Ŷ) from the proposed two-prompt model has a significantly lower error rate in classifying the input text and providing a more accurate CoT-based reasoning, leading to improved classification accuracy.

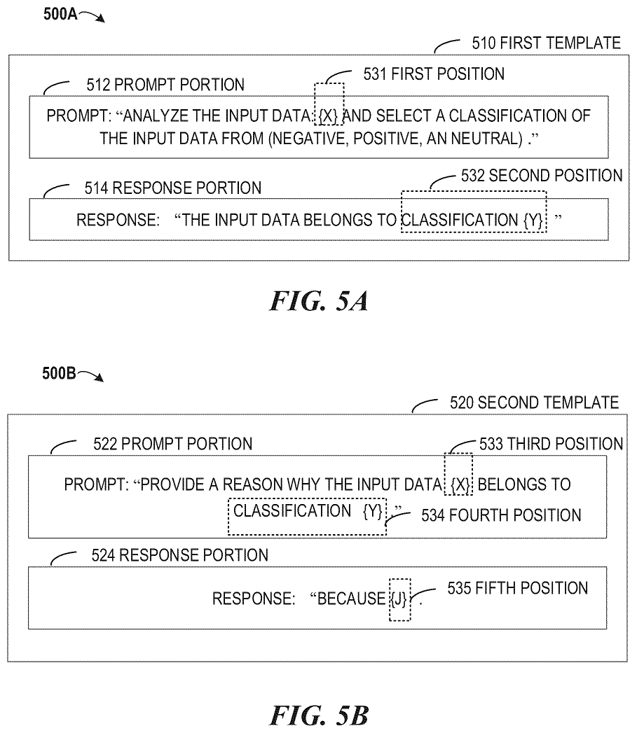

In implementations of the present disclosure, a first template corresponding to the first task may be obtained. An example of the first template may be described with reference to FIG. 5A, which illustrates an example diagram 500A of the first template according to implementations of the present disclosure. As shown in FIG. 5A, the first template 510 may be represented in a natural language format, and comprises a first position 531 for inserting the input data and a second position 532 for inserting the classification. The first sample 210 may be obtained by updating the first template with the input data and the classification of the input data. It is to be noted that the first template 510 shown in FIG. 5A is merely an example and there may be other first templates which are suitable for inserting the input data and classification. For example, the first template 510 may be: “Prompt: provide a classification of the input data {X}. response: classification {Y}”. With these implementations of the present disclosure, by proving the first sample, during the fine-tuning process, the machine learning model can better grasp most of the knowledge related to the classification task. Therefore, the machine learning model can better solve problems related to classification.

In implementations of the present disclosure, the first prompt in the first sample 210 may be obtained by updating a prompt portion 512 in the first template 510 with the input data. By updating the prompt portion 512, the first prompt includes input data inserted at the first position 531. The first response in the first sample 210 may be obtained by updating a response portion 514 in the first template 510 with the classification. By updating the response portion 514, the first response includes the classification inserted at the second position 532.

In implementations of the present disclosure, a plurality of candidate classifications of the input data may be added into the first prompt based on a length limit for the first prompt. There may be a length limit for the prompt input to the machine learning model 120. In accordance with a determination that the length of the first prompt does not exceed the length limit, candidate classifications (e.g., negative, positive or neutral) of the input data may be added into the first prompt. With these implementations of the present disclosure, the classification task is more accurately described and thus the accuracy of the classification output by the machine learning model may be improved.

In implementations of the present disclosure, a second template corresponding to the second task may be obtained. An example of the second template may be described with reference to FIG. 5B, which illustrates an example diagram 500B of the second template according to implementations of the present disclosure. As shown in FIG. 5B, the second template 520 may be represented in a natural language format, and comprise a third position 533 for inserting the input data, a fourth position 534 for inserting the classification, and a fifth position 535 for inserting the reason. The second sample 520 may be obtained by updating the second template with the input data, the classification of the input data, and the reason. It is to be noted that the second template 520 shown in FIG. 5B is merely an example and there may be other second templates which are suitable for inserting the input data, classification and reason. For example, the second template may be: “Prompt: explain why the input data {X}belongs to the classification {Y}. Response: the reason is: {J}”. With these implementations of the present disclosure, by proving the second sample, during the fine-tuning process, the machine learning model can better grasp most of the knowledge related to the reasoning task. Therefore, the machine learning model can better solve problems related to proving reason why the input data belong to the classification.

In implementations of the present disclosure, the second prompt in the second sample 520 may be obtained by updating a prompt portion 522 in the second template 520 with the input data and classification. By updating the prompt portion 522, the second prompt includes the input data inserted at the third position 533 and the classification inserted at the fourth position 534. The second response in the second sample 520 may be obtained by updating a response portion 524 in the second template 520 with the reason. By updating the response portion 524, the second response includes the reason inserted at the fifth position 535.

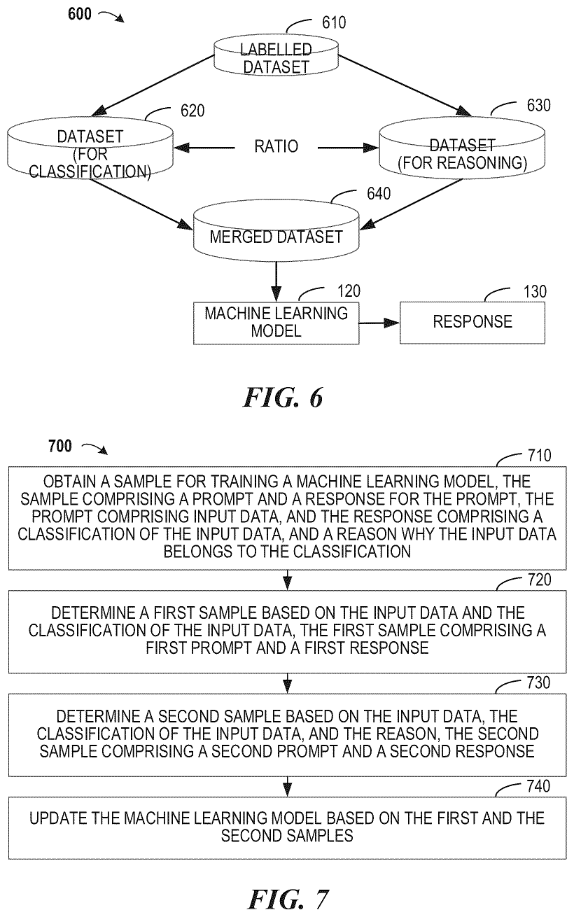

The construction of a dataset for training the machine learning model 120 may be described with reference to FIG. 6, which illustrates an example diagram of construction of a dataset for training the machine learning model 120 according to implementations of the present disclosure. As shown in FIG. 6, a labelled dataset 610 may be used to generate a dataset 620 for classification and a dataset 630 for reasoning. A ratio between a first number of a first plurality of first samples (also referred to as dataset 620) and a second number of a second plurality of second samples (also referred to as dataset 630) based on a purpose of the machine learning model 120. The first plurality of first samples 210 and the second plurality of second samples 220 may be obtained based on the ratio. In some examples, the first plurality of first samples 210 and the second plurality of second samples 220 may form a merged dataset 640 which is used to train the machine learning model 120.

In some implementations, the purpose of the machine learning model 120 may expect the accuracy of the classification performed by the machine learning model 120 to be more accurate. The first number of the first plurality of first samples 210 may be relatively large, and thus the ratio may be set to a value above 1. In some implementations, the purpose of the machine learning model 120 may expect the accuracy of reason given by the machine learning model 120 to be more accurate. The second number of the second plurality of second samples 220 may be relatively large, and thus the ratio may be set to a value below 1. With these implementations of the present disclosure, the performance of both tasks may be improved according to preference.

In implementations of the present disclosure, a batch of samples may be selected from the first plurality of first samples 210 and the second plurality of second samples 220 based on a predetermined batch number. In an example, the predetermined batch number may be 128. After the batch of samples is selected, the machine learning model may be updated based on the batch of samples. With these implementations of the present disclosure, by training the machine learning model with a batch in each iteration, the accuracy of output by the machine learning model may be enhanced.

In implementations of the present disclosure, in response to receiving a target prompt that comprising target input data, a target classification of the target input data, and a reason why the target input data belongs to the target classification may be provided by the machine learning model 120. After the machine learning model 120 is trained, in an inference stage, the machine learning model 120 may output the target classification and the reason based on the received target prompt. With these implementations of the present disclosure, the result output by the machine learning model may be more accurate after training on two independent tasks.

The above paragraphs have described details for data classification. According to implementations of the present disclosure, a method is provided for data classification. Reference will be made to FIG. 7 for more details about the method, where FIG. 7 illustrates an example flowchart of a method 700 for data classification according to implementations of the present disclosure. At block 710, a sample for training a machine learning model is obtained. The sample comprises a prompt and a response for the prompt, the prompt comprises input data, and the response comprises a classification of the input data, and a reason why the input data belongs to the classification. At block 720, a first sample is determined based on the input data and the classification of the input data, and the first sample comprises a first prompt and a first response. At block 730, a second sample is determined based on the input data, the classification of the input data, and the reason, and the second sample comprises a second prompt and a second response. At block 740, the machine learning model is updated based on the first and the second samples.

In implementations of the present disclosure, the machine learning model implements a task for outputting a classification of target data and a response why the target data belongs to the classification, and determining the first and second samples comprises: dividing the task into a first task and a second task that is implemented after the first task, the first task outputting a classification of the target data, and the second task outputting a response why the target data belongs to the classification; obtaining the first sample, according to the first task, based on the input data and the classification of the input data; and obtaining the second sample, according to the second task, based on the input data, the classification of the input data, and the reason.

In implementations of the present disclosure, obtaining the first sample comprises: obtaining a first template corresponding to the first task, the first template being represented in a natural language format, and comprising a first position for inserting the input data and a second position for inserting the classification; and obtaining the first sample by updating the first template with the input data and the classification of the input data.

In implementations of the present disclosure, obtaining the first sample by updating the first template with the input data and the classification of the input data comprises: obtaining the first prompt in the first sample by updating a prompt portion in the first template with the input data; and obtaining the first response in the first sample by updating a response portion in the first template with the classification.

In implementations of the present disclosure, obtaining the first prompt comprises: adding a plurality of candidate classifications of the input data into the first prompt based on a length limit for the first prompt.

In implementations of the present disclosure, obtaining the second sample comprises: obtaining a second template corresponding to the second task, the second template being represented in a natural language format, and comprising a third position for inserting the input data, a fourth position for inserting the classification, and a fifth position for inserting the reason; and obtaining the second sample by updating the second template with the input data, the classification of the input data, and the reason.

In implementations of the present disclosure, obtaining the second sample by updating the second template with the input data, the classification of the input data, and the reason comprises: obtaining the second prompt in the second sample by updating a prompt portion in the second template with the input data and classification; and obtaining the second response in the second sample by updating a response portion in the second template with the reason.

In implementations of the present disclosure, the method 700 further comprises: determining a ratio between a first number of a first plurality of first samples and a second number of a second plurality of second samples based on a purpose of the machine learning model; and obtaining the first plurality of first samples and the second plurality of second samples based on the ratio.

In implementations of the present disclosure, updating the machine learning model based on the first and the second samples comprises: selecting a batch of samples from the first plurality of first samples and the second plurality of second samples based on a predetermined batch number; and updating the machine learning model based on the batch of samples.

In implementations of the present disclosure, the method 700 further comprises: in response to receiving a target prompt that comprising target input data, providing, by the machine learning model, a target classification of the target input data, and a reason why the target input data belongs to the target classification.

According to implementations of the present disclosure, an apparatus is provided for data classification. The apparatus comprises: a sample obtaining module configured for obtaining a sample for training a machine learning model, the sample comprising a prompt and a response for the prompt, the prompt comprising input data, and the response comprising a classification of the input data, and a reason why the input data belongs to the classification; a first sample determining module configured for determining a first sample based on the input data and the classification of the input data, the first sample comprising a first prompt and a first response; a second sample determining module configured for determining a second sample based on the input data, the classification of the input data, and the reason, the second sample comprising a second prompt and a second response; and a model updating module configured for updating the machine learning model based on the first and the second samples.

According to implementations of the present disclosure, an electronic device is provided for implementing the method 700. The electronic device comprises: a computer processor coupled to a computer-readable memory unit, the memory unit comprising instructions that when executed by the computer processor implements a method for data classification. The method comprises: obtaining a sample for training a machine learning model, the sample comprising a prompt and a response for the prompt, the prompt comprising input data, and the response comprising a classification of the input data, and a reason why the input data belongs to the classification; determining a first sample based on the input data and the classification of the input data, the first sample comprising a first prompt and a first response; determining a second sample based on the input data, the classification of the input data, and the reason, the second sample comprising a second prompt and a second response; and updating the machine learning model based on the first and the second samples.

In implementations of the present disclosure, the machine learning model implements a task for outputting a classification of target data and a response why the target data belongs to the classification, and determining the first and second samples comprises: dividing the task into a first task and a second task that is implemented after the first task, the first task outputting a classification of the target data, and the second task outputting a response why the target data belongs to the classification; obtaining the first sample, according to the first task, based on the input data and the classification of the input data; and obtaining the second sample, according to the second task, based on the input data, the classification of the input data, and the reason.

In implementations of the present disclosure, obtaining the first sample comprises: obtaining a first template corresponding to the first task, the first template being represented in a natural language format, and comprising a first position for inserting the input data and a second position for inserting the classification; and obtaining the first sample by updating the first template with the input data and the classification of the input data.

In implementations of the present disclosure, obtaining the first sample by updating the first template with the input data and the classification of the input data comprises: obtaining the first prompt in the first sample by updating a prompt portion in the first template with the input data; and obtaining the first response in the first sample by updating a response portion in the first template with the classification.

In implementations of the present disclosure, obtaining the first prompt comprises: adding a plurality of candidate classifications of the input data into the first prompt based on a length limit for the first prompt.

In implementations of the present disclosure, obtaining the second sample comprises: obtaining a second template corresponding to the second task, the second template being represented in a natural language format, and comprising a third position for inserting the input data, a fourth position for inserting the classification, and a fifth position for inserting the reason; and obtaining the second sample by updating the second template with the input data, the classification of the input data, and the reason.

In implementations of the present disclosure, obtaining the second sample by updating the second template with the input data, the classification of the input data, and the reason comprises: obtaining the second prompt in the second sample by updating a prompt portion in the second template with the input data and classification; and obtaining the second response in the second sample by updating a response portion in the second template with the reason.

In implementations of the present disclosure, the method 700 further comprises: determining a ratio between a first number of a first plurality of first samples and a second number of a second plurality of second samples based on a purpose of the machine learning model; and obtaining the first plurality of first samples and the second plurality of second samples based on the ratio.

In implementations of the present disclosure, updating the machine learning model based on the first and the second samples comprises: selecting a batch of samples from the first plurality of first samples and the second plurality of second samples based on a predetermined batch number; and updating the machine learning model based on the batch of samples.

In implementations of the present disclosure, the method 700 further comprises: in response to receiving a target prompt that comprising target input data, providing, by the machine learning model, a target classification of the target input data, and a reason why the target input data belongs to the target classification.

According to implementations of the present disclosure, a computer program product is provided, the computer program product comprising a computer readable storage medium having program instructions embodied therewith, the program instructions executable by an electronic device to cause the electronic device to perform the method 700.

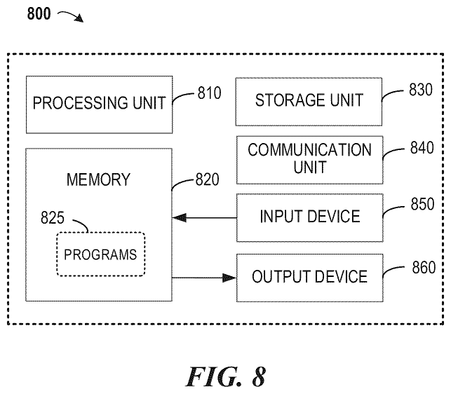

FIG. 8 illustrates a block diagram of a computing device 800 in which various implementations of the present disclosure can be implemented. It would be appreciated that the computing device 800 shown in FIG. 8 is merely for purpose of illustration, without suggesting any limitation to the functions and scopes of the present disclosure in any manner. The computing device 800 may be used to implement the above method 700 in implementations of the present disclosure. As shown in FIG. 8, the computing device 800 may be a general-purpose computing device. The computing device 800 may at least comprise one or more processors or processing units 810, a memory 820, a storage unit 830, one or more communication units 840, one or more input devices 850, and one or more output devices 860.

The processing unit 810 may be a physical or virtual processor and can implement various processes based on programs 825 stored in the memory 820. In a multi-processor system, multiple processing units execute computer executable instructions in parallel so as to improve the parallel processing capability of the computing device 800. The processing unit 810 may also be referred to as a central processing unit (CPU), a microprocessor, a controller, or a microcontroller.

The computing device 800 typically includes various computer storage medium. Such medium can be any medium accessible by the computing device 800, including, but not limited to, volatile and non-volatile medium, or detachable and non-detachable medium. The memory 820 can be a volatile memory (for example, a register, cache, Random Access Memory (RAM)), a non-volatile memory (such as a Read-Only Memory (ROM), Electrically Erasable Programmable Read-Only Memory (EEPROM), or a flash memory), or any combination thereof. The storage unit 830 may be any detachable or non-detachable medium and may include a machine-readable medium such as a memory, flash memory drive, magnetic disk, or another other media, which can be used for storing information and/or data and can be accessed in the computing device 800.

The computing device 800 may further include additional detachable/non-detachable, volatile/non-volatile memory medium. Although not shown in FIG. 8, it is possible to provide a magnetic disk drive for reading from and/or writing into a detachable and non-volatile magnetic disk and an optical disk drive for reading from and/or writing into a detachable non-volatile optical disk. In such cases, each drive may be connected to a bus (not shown) via one or more data medium interfaces.

The communication unit 840 communicates with a further computing device via the communication medium. In addition, the functions of the components in the computing device 800 can be implemented by a single computing cluster or multiple computing machines that can communicate via communication connections. Therefore, the computing device 800 can operate in a networked environment using a logical connection with one or more other servers, networked personal computers (PCs) or further general network nodes.

The input device 850 may be one or more of a variety of input devices, such as a mouse, keyboard, tracking ball, voice-input device, and the like. The output device 860 may be one or more of a variety of output devices, such as a display, loudspeaker, printer, and the like. By means of the communication unit 840, the computing device 800 can further communicate with one or more external devices (not shown) such as the storage devices and display device, with one or more devices enabling the user to interact with the computing device 800, or any devices (such as a network card, a modem, and the like) enabling the computing device 800 to communicate with one or more other computing devices, if required. Such communication can be performed via input/output (I/O) interfaces (not shown).

In some implementations, instead of being integrated in a single device, some, or all components of the computing device 800 may also be arranged in cloud computing architecture. In the cloud computing architecture, the components may be provided remotely and work together to implement the functionalities described in the present disclosure. In some implementations, cloud computing provides computing, software, data access and storage service, which will not require end users to be aware of the physical locations or configurations of the systems or hardware providing these services. In various implementations, the cloud computing provides the services via a wide area network (such as Internet) using suitable protocols. For example, a cloud computing provider provides applications over the wide area network, which can be accessed through a web browser or any other computing components. The software or components of the cloud computing architecture and corresponding data may be stored on a server at a remote position. The computing resources in the cloud computing environment may be merged or distributed at locations in a remote data center. Cloud computing infrastructures may provide the services through a shared data center, though they behave as a single access point for the users. Therefore, the cloud computing architectures may be used to provide the components and functionalities described herein from a service provider at a remote location. Alternatively, they may be provided from a conventional server or installed directly or otherwise on a client device.

The functionalities described herein can be performed, at least in part, by one or more hardware logic components. For example, and without limitation, illustrative types of hardware logic components that can be used include Field-Programmable Gate Arrays (FPGAs), Application-specific Integrated Circuits (ASICs), Application-specific Standard Products (ASSPs), System-on-a-chip systems (SOCs), Complex Programmable Logic Devices (CPLDs), and the like.

Program code for carrying out the methods of the subject matter described herein may be written in any combination of one or more programming languages. The program code may be provided to a processor or controller of a general-purpose computer, special purpose computer, or other programmable data processing apparatus such that the program code, when executed by the processor or controller, causes the functions/operations specified in the flowcharts and/or block diagrams to be implemented. The program code may be executed entirely or partly on a machine, executed as a stand-alone software package partly on the machine, partly on a remote machine, or entirely on the remote machine or server.

In the context of this disclosure, a machine-readable medium may be any tangible medium that may contain or store a program for use by or in connection with an instruction execution system, apparatus, or device. The machine-readable medium may be a machine-readable signal medium or a machine-readable storage medium. A machine-readable medium may include but not limited to an electronic, magnetic, optical, electromagnetic, infrared, or semiconductor system, apparatus, or device, or any suitable combination of the foregoing. More specific examples of the machine-readable storage medium would include an electrical connection having one or more wires, a portable computer diskette, a hard disk, a random-access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are illustrated in a particular order, this should not be understood as requiring that such operations are performed in the particular order shown or in sequential order, or that all illustrated operations are performed to achieve the desired results. In certain circumstances, multitasking and parallel processing may be advantageous. Likewise, while several specific implementation details are contained in the above discussions, these should not be construed as limitations on the scope of the subject matter described herein, but rather as descriptions of features that may be specific to particular implementations. Certain features that are described in the context of separate implementations may also be implemented in combination in a single implementation. Rather, various features described in a single implementation may also be implemented in multiple implementations separately or in any suitable sub-combination.

Although the subject matter has been described in language specific to structural features and/or methodological acts, it is to be understood that the subject matter specified in the appended claims is not necessarily limited to the specific features or acts described above. Rather, the specific features and acts described above are disclosed as example forms of implementing the claims.

From the foregoing, it will be appreciated that specific implementations of the presently disclosed technology have been described herein for purposes of illustration, but that various modifications may be made without deviating from the scope of the disclosure. Accordingly, the presently disclosed technology is not limited except as by the appended claims.

Implementations of the subject matter and the functional operations described in the present disclosure can be implemented in various systems, digital electronic circuitry, or in computer software, firmware, or hardware, including the structures disclosed in this specification and their structural equivalents, or in combinations of one or more of them. Implementations of the subject matter described in this specification can be implemented as one or more computer program products, i.e., one or more modules of computer program instructions encoded on a tangible and non-transitory computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them. The term “data processing unit” or “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of nonvolatile memory, media, and memory devices, including by way of example semiconductor memory devices, e.g., EPROM, EEPROM, and flash memory devices. The processor and the memory can be supplemented by, or incorporated in, special purpose logic circuitry.

It is intended that the specification, together with the drawings, be considered exemplary only, where exemplary means an example. As used herein, the use of “or” is intended to include “and/or”, unless the context clearly indicates otherwise.

While the present disclosure contains many specifics, these should not be construed as limitations on the scope of any disclosure or of what may be claimed, but rather as descriptions of features that may be specific to particular implementations of particular disclosures. Certain features that are described in the present disclosure in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are illustrated in the drawings in a particular order, this should not be understood as requiring that such operations be performed in the particular order shown or in sequential order, or that all illustrated operations be performed, to achieve desirable results. Moreover, the separation of various system components in the implementations described in the present disclosure should not be understood as requiring such separation in all implementations. Only a few implementations and examples are described and other implementations, enhancements and variations can be made based on what is described and illustrated in the present disclosure.

1. A method for data classification, comprising:
obtaining a sample for training a machine learning model, the sample comprising a prompt and a response for the prompt, the prompt comprising input data, and the response comprising a classification of the input data, and a reason why the input data belongs to the classification;
determining a first sample based on the input data and the classification of the input data, the first sample comprising a first prompt and a first response;
determining a second sample based on the input data, the classification of the input data, and the reason, the second sample comprising a second prompt and a second response; and
updating the machine learning model based on the first and the second samples.

2. The method according to claim 1, wherein the machine learning model implements a task for outputting a classification of target data and a response why the target data belongs to the classification, and determining the first and second samples comprises:
dividing the task into a first task and a second task that is implemented after the first task, the first task outputting a classification of the target data, and the second task outputting a response why the target data belongs to the classification;
obtaining the first sample, according to the first task, based on the input data and the classification of the input data; and
obtaining the second sample, according to the second task, based on the input data, the classification of the input data, and the reason.

3. The method according to claim 2, wherein obtaining the first sample comprises:
obtaining a first template corresponding to the first task, the first template being represented in a natural language format, and comprising a first position for inserting the input data and a second position for inserting the classification; and
obtaining the first sample by updating the first template with the input data and the classification of the input data.

4. The method according to claim 3, wherein obtaining the first sample by updating the first template with the input data and the classification of the input data comprises:
obtaining the first prompt in the first sample by updating a prompt portion in the first template with the input data; and
obtaining the first response in the first sample by updating a response portion in the first template with the classification.

5. The method according to claim 4, wherein obtaining the first prompt comprises: adding a plurality of candidate classifications of the input data into the first prompt based on a length limit for the first prompt.

6. The method according to claim 2, wherein obtaining the second sample comprises:
obtaining a second template corresponding to the second task, the second template being represented in a natural language format, and comprising a third position for inserting the input data, a fourth position for inserting the classification, and a fifth position for inserting the reason; and
obtaining the second sample by updating the second template with the input data, the classification of the input data, and the reason.

7. The method according to claim 6, wherein obtaining the second sample by updating the second template with the input data, the classification of the input data, and the reason comprises:
obtaining the second prompt in the second sample by updating a prompt portion in the second template with the input data and classification; and
obtaining the second response in the second sample by updating a response portion in the second template with the reason.

8. The method according to claim 1, further comprising:
determining a ratio between a first number of a first plurality of first samples and a second number of a second plurality of second samples based on a purpose of the machine learning model; and
obtaining the first plurality of first samples and the second plurality of second samples based on the ratio.

9. The method according to claim 8, wherein updating the machine learning model based on the first and the second samples comprises:
selecting a batch of samples from the first plurality of first samples and the second plurality of second samples based on a predetermined batch number; and
updating the machine learning model based on the batch of samples.

10. The method according to claim 1, further comprising:
in response to receiving a target prompt that comprising target input data, providing, by the machine learning model, a target classification of the target input data, and a reason why the target input data belongs to the target classification.

11. An electronic device, comprising a computer processor coupled to a computer-readable memory unit, the memory unit comprising instructions that when executed by the computer processor implements a method for data classification, the method comprises:
obtaining a sample for training a machine learning model, the sample comprising a prompt and a response for the prompt, the prompt comprising input data, and the response comprising a classification of the input data, and a reason why the input data belongs to the classification;
determining a first sample based on the input data and the classification of the input data, the first sample comprising a first prompt and a first response;
determining a second sample based on the input data, the classification of the input data, and the reason, the second sample comprising a second prompt and a second response; and
updating the machine learning model based on the first and the second samples.

12. The electronic device according to claim 11, wherein the machine learning model implements a task for outputting a classification of target data and a response why the target data belongs to the classification, and determining the first and second samples comprises:
dividing the task into a first task and a second task that is implemented after the first task, the first task outputting a classification of the target data, and the second task outputting a response why the target data belongs to the classification;
obtaining the first sample, according to the first task, based on the input data and the classification of the input data; and
obtaining the second sample, according to the second task, based on the input data, the classification of the input data, and the reason.

13. The electronic device according to claim 12, wherein obtaining the first sample comprises:
obtaining a first template corresponding to the first task, the first template being represented in a natural language format, and comprising a first position for inserting the input data and a second position for inserting the classification; and
obtaining the first sample by updating the first template with the input data and the classification of the input data.

14. The electronic device according to claim 13, wherein obtaining the first sample by updating the first template with the input data and the classification of the input data comprises:
obtaining the first prompt in the first sample by updating a prompt portion in the first template with the input data; and
obtaining the first response in the first sample by updating a response portion in the first template with the classification.

15. The electronic device according to claim 12, wherein obtaining the second sample comprises:
obtaining a second template corresponding to the second task, the second template being represented in a natural language format, and comprising a third position for inserting the input data, a fourth position for inserting the classification, and a fifth position for inserting the reason; and
obtaining the second sample by updating the second template with the input data, the classification of the input data, and the reason.

16. The electronic device according to claim 15, wherein obtaining the second sample by updating the second template with the input data, the classification of the input data, and the reason comprises:
obtaining the second prompt in the second sample by updating a prompt portion in the second template with the input data and classification; and
obtaining the second response in the second sample by updating a response portion in the second template with the reason.

17. The electronic device according to claim 11, the method further comprising:
determining a ratio between a first number of a first plurality of first samples and a second number of a second plurality of second samples based on a purpose of the machine learning model; and
obtaining the first plurality of first samples and the second plurality of second samples based on the ratio.

18. The electronic device according to claim 17, wherein updating the machine learning model based on the first and the second samples comprises:
selecting a batch of samples from the first plurality of first samples and the second plurality of second samples based on a predetermined batch number; and
updating the machine learning model based on the batch of samples.

19. The electronic device according to claim 18, wherein the method further comprises:
in response to receiving a target prompt that comprising target input data, providing, by the machine learning model, a target classification of the target input data, and a reason why the target input data belongs to the target classification.

20. A computer program product, the computer program product comprising a computer readable storage medium having program instructions embodied therewith, the program instructions executable by an electronic device to cause the electronic device to perform a method for data classification, the method comprises:
obtaining a sample for training a machine learning model, the sample comprising a prompt and a response for the prompt, the prompt comprising input data, and the response comprising a classification of the input data, and a reason why the input data belongs to the classification;
determining a first sample based on the input data and the classification of the input data, the first sample comprising a first prompt and a first response;
determining a second sample based on the input data, the classification of the input data, and the reason, the second sample comprising a second prompt and a second response; and
updating the machine learning model based on the first and the second samples.
